(19) United States
(12) Patent Application Publication
(10) Pub. No.: US 2026/0197687 A1
(43) Pub. Date: Jul. 9, 2026

(54) SYSTEMS AND METHODS FOR USER EQUIPMENT ASSISTED FEATURE CORRELATION ESTIMATION FEEDBACK

(71) Applicant: Telefonaktiebolaget LM Ericsson (PUBL), Stockholm (SE)

(72) Inventors: Henrik Rydén, STOCKHOLM (SE); Daniel Chen Larsson, LUND (SE); Andres Reial, HÖLLVIKEN (SE)

(21) Appl. No.: 18/868,285

(22) PCT Filed: May 29, 2023
(86) PCT No.: PCT/EP2023/064330

§ 371 Date: Nov. 22, 2024

Related U.S. Application Data
(60) Provisional application No. 63/346,933, filed on May 30, 2022.

(51) Int. Cl. H04W 24/10; H04L 41/16; H04W 8/22; H04W 76/20

(52) U.S. Cl. CPC H04W 24/10; H04L 41/16; H04W 8/22; H04W 76/20

(57) ABSTRACT

A method (1100) performed by a user equipment, UE, (512) for assisted feature correlation estimation includes transmitting (1102), to a network node (510), assistance information for input into a machine learning model. The assistance information includes at least one correlation between a plurality of features.

### TECHNICAL FIELD

The present disclosure relates, in general, to wireless communications and, more particularly, systems and methods for User Equipment (UE) assisted feature correlation estimation feedback.

### BACKGROUND

Machine learning (ML) can be used to find a predictive function for a given dataset, which is typically a mapping between a given input to an output. The predictive function (or mapping function) is generated in a training phase, where the training phase assumes knowledge of both the input and output. The test phase comprises predicting the output for a given input. Applications of ML are for example curve fitting, facial recognition, and email-spam filtering.

In general, the performance of the machine learner is proportional to the correlation between the input and the output, and one key problem in ML is to find/create good features. FIGS. 1A and 1B illustrate an example of classification with ML. This is just one example type of ML, and in this example, the task is to train a predictive function that separates the two classes (circle and cross class).

Specifically, FIG. 1A illustrates the features providing less class separation in comparison with using the features in FIG. 1B. For example, in FIG. 1A, features 1 and 2 provide low separation of the output class. This leads to worse prediction performance in comparison with FIG. 1B, which shows that using features 3 and 4 enable a better separation and classifying performance.

### Feature Correlations

Spearman and Pearson are two statistical methods for calculating the strength of correlation between two variables or features. Pearson Correlation Coefficient generally works well with continuous variables that have a linear relationship. The formula for the Pearson product moment correlation coefficient, r, is:

$$r = \frac{\sum ( x - \overline{x} ) ( y - \overline{y} )}{\sqrt{\sum {( x - \overline{x} )}^{2} \sum {( y - \overline{y} )}^{2}}} \qquad ( Eq . 1 )$$

In general, a Pearson Correlation Coefficient that is close to one can indicate high prediction performance when predicting the second value based on the first value or vice-versa. It also indicates that less measurements are needed to build such predictor. Thus, less measurements are needed to average out noise.

FIGS. 2A and 2B illustrate two examples of different Pearson's Coefficients for different relation between variable A & B. FIG. 2A requires less data than FIG. 2B in order to build a predictor that predicts variable B given variable A measurements or vice versa.

### ML in 3GPP

There is an ongoing study item in RAN3 covering principles for Radio Access Network (RAN) intelligence enabled by Artificial Intelligence (AI), the functional framework (e.g., the AI functionality and the input/output of the component for AI enabled optimization), and use cases and solutions of AI enabled Radio Access Network (RAN). See, 3GPP TR 37.817.

FIG. 3 illustrates the functional framework for RAN intelligence. The functional framework outlines a set of functions, which is part of the ML workflow. For example, data collection is a function that provides input data to Model training and Model inference functions. AI/ML algorithm specific data preparation (e.g., data pre-processing and cleaning, formatting, and transformation) is not carried out in the Data Collection function. Examples of input data may include measurements from UEs or different network entities, feedback from Actor, and/or output from an AI/ML model. Training data includes data needed as input for the AI/ML Model Training function. Inference data includes data needed as input for the AI/ML Model Inference function.

### ML Applications in RAN

ML applications in RAN are explained below using several examples:

### Example 1: Beam Measurement Prediction

Generally, a base station may use reference signals to obtain measurements performed by the UE on the beams transmitted by a base station (e.g., to assess the quality of the beams). In general, the reference signals transmitted by at least one base station to the UE may comprise at least one of a Channel State Information-Reference Signal (CSI-RS), a Synchronization Signal Block (SSB), a Primary Synchronization Signal (PSS), a Secondary Synchronization Signal (SSS), and a Cell Reference Signal (CRS). More specifically, a UE may assess beam qualities via measurements on the SSB (e.g., corresponding to a Synchronization Signal/Physical Broadcast Channel (PBCH) block) in a 5^{th} Generation (5G) (e.g., New Radio (NR)) network, or via measurements on the CSI-RS resources in a 5G (e.g., NR) network or a 4th Generation (4G) (e.g., Long Term Evolution (LTE)) network.

The device can use a ML model to reduce its measurement related to such reference signals. In NR, one can request a device to measure on a set of CSI-RS beams. A stationary device typically experiences less variations in beam quality in comparison to a moving device. The stationary device can, therefore, save battery by reducing its beam measurement by instead using an ML model to predict the strength instead of measuring it. It can do this, for example, by measuring a subset of the beams and predicting the rest of the beams and/or reduce the measurement rate in time and interpolate using ML.

### Example 2: Secondary Carrier Coverage Prediction

In order to detect a node on another frequency using target carrier prediction as described by previous techniques and methods, the device is required to perform signalling of source carrier information. For example, a mobile device periodically transmits source carrier information to enable the macro node to handover the device to another node operating at a higher frequency. Using target carrier prediction, the device does not need to perform inter-frequency measurements, leading to energy savings at the device. However, frequent signalling of source carrier information to enable prediction of the secondary frequency can lead to an additional overhead and should, thus, be minimized. The risk of not performing frequent periodic signalling is missing an opportunity of doing an inter-frequency handover to a less-loaded cell on another carrier.

### Example 3: Signal Quality Drop Prediction

FIG. 4 illustrates two devices moving on similar paths. Based on received device data from measurement reports, the network can learn, for example, what sequence of signal quality measurements (e.g., Reference Signal Received Power (RSRP)) result in a large signal quality drop (e.g., turning around the corners in figure below), for example, by dividing a periodic reported RSRP data into a training and prediction window.

In the depicted example in FIG. 4, two devices are turning around the same corner. According to the location plot, the device marked by a dashed line first turns around the corner and experiences a large signal quality drop. The idea is to then mitigate the drop of a second device also turning around the same corner by using learning from the experience of the first device.

The learning can be done by feeding RSRP in t₁, . . . , tₙ into a ML model (e.g., Neural network). The RSRP in tₙ₊₁, t_{n+2 can} then be learned. After the ML model is trained, the network can download the ML model to the device, which then predicts future signal quality values. The predicted signal quality values can then be used to avoid radio-link failure by:
initiating inter-frequency handover,
setting handover/reselection parameters, and/or
changing device scheduler priority such as, for example, scheduling a device when the expected signal quality is good.

### See, PCT Patent Publication, WO 2020/226542 (A1), “NETWORK NODE, USER EQUIPMENT AND METHODS FOR HANDLING SIGNAL QUALITY VARIATIONS”, 2020 Nov. 12.

### Example 4: Radio-Fingerprint Based Positioning

The measurements on the plurality of beams in NR can enable the network to get an improved radio-fingerprint of the device in comparison to previous technologies (e.g., LTE). The natural application of radio-fingerprinting is positioning, where it has been shown how a radiolocation enabled by advanced antenna systems can accurately locate a device even in the absence of Line of Sight (LoS).

There currently exist certain challenge(s), however. For example, it can be challenging for the network to understand the potential performance when training an ML-model to predict a certain beam quality, carrier coverage, or a forecasted signal quality. For example, in the case of training a model for beam prediction, it can be hard for the network to understand, before collecting an extensive amount of data, the potential in predicting a beam based on measurements on a subset of beams. This could lead to extensive reporting of data by a UE, even where it is still uncertain if the reported data will provide any useful information for the ML-model training. The data collection functionality, which is part of the ongoing discussion in 3GPP, needs to handle the complex trade-off in enabling ML-models without unnecessary large signalling overhead.

One possible situation is that only a fraction of the potential ML models could fulfill a certain performance requirement for being deployed using the collected data. For example, the time series of UE reported signal quality measurements don't have any strong correlation or pattern, or the beam signal quality measurements are largely uncorrelated (more complex beam relations than one can expect). In another example, it can be challenging to understand which radio measurements contribute to create a unique fingerprint for the positioning use case.

### SUMMARY

Certain aspects of the disclosure and their embodiments may provide solutions to these or other challenges. For example, methods and systems are provided for configuring devices to calculate assistance information comprising the correlation among potential features, used by a network node that determines whether to build a certain ML model. As another example, methods and systems are provided for determining the input features for said model, or whether to use data and/or specific features from a given UE for training a ML model. The ML model can, for example, comprise of beam measurement prediction, carrier coverage prediction, signal quality forecast, radio-fingerprint-based positioning, or other related methods.

According to certain embodiments, a method performed by a UE for assisted feature correlation estimation includes transmitting, to a network node, assistance information for input into a ML model. The assistance information comprises at least one correlation between a plurality of features.

According to certain embodiments, a UE for assisted feature correlation estimation is adapted to transmit, to a network node, assistance information for input into a machine learning model. The assistance information comprises at least one correlation between a plurality of features.

According to certain embodiments, a method performed by a network node for assisted feature correlation estimation includes receiving, from at least one UE, assistance information comprising at least one correlation between a plurality of features. The network node performs at least one network operation based on the assistance information.

According to certain embodiments, a network node for assisted feature correlation estimation is adapted to receive, from at least one UE, assistance information comprising at least one correlation between a plurality of features. The network node performs at least one network operation based on the assistance information.

Certain embodiments may provide one or more of the following technical advantage(s). For example, certain embodiments may provide a technical advantage of enabling more efficient training of ML models and reducing the amount of unnecessary data signaled from the wireless device. By having a correlation report as a first step, only a limited part of data is sent. Based on the correlation report, the limited part of the data is representative of a large amount of data to be used when training the model at the network node.

As another example, certain embodiments may provide a technical advantage of enabling features that are uncorrelated. For example, when creating a beam prediction ML model, the UE correlation report may indicate whether or not two beams are independent by calculating the Pearson coefficient, for example. As such, a further technical advantage may be enabling a network node to find a minimum set of beams to transmit. For example, the number and identities of beams that can or cannot be predicted due to their low correlation properties with other beams may be identified.

As still another example, a technical advantage of certain embodiments may include finding feature importance values. These feature importance values may indicate which features correlate with a certain response variable such as, for example, how many past measurements are needed for forecasting a certain beam value or which radio measurements can be used to predict a certain beam quality or to estimate the geolocation using fingerprinting techniques.

As still another example, certain embodiments may provide a technical advantage of reduced model complexity. For example, only the uncorrelated features may be used when training the model. This can be seen as feature dimensionality reduction technique.

As yet another example, certain embodiments may provide a technical advantage of reducing the amount of UE signaling. For example, the UE may report a subset of the features that was first intended as model input. As another example, where there is a certain correlation property (e.g., independent from other input features, and/or high correlation with the response variable), only the UE measurements to be used for model training may be reported.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIGS. 1A and 1B illustrate an example of classification with ML;

FIGS. 2A and 2B illustrate two examples of different Pearsons coefficients for different relation between variable A & B;

FIG. 3 illustrates the functional framework for RAN intelligence;

FIG. 4 illustrates two devices moving on similar paths;

FIG. 5 illustrates an example method by a wireless device for correlation estimation, according to certain embodiments;

FIG. 6 illustrates example methods by a network node (e.g., gNB) and wireless device (e.g., UE), respectively, for training a ML model, according to certain embodiments;

FIG. 7 illustrates example data collected on four different SSB-beams, according to certain embodiments;

FIG. 8 illustrates an example Pearson coefficient matrix, according to certain embodiments;

FIG. 9 illustrates an example communication system, according to certain embodiments;

FIG. 10 illustrates an example UE, according to certain embodiments;

FIG. 11 illustrates an example network node, according to certain embodiments;

FIG. 12 illustrates a block diagram of a host, according to certain embodiments;

FIG. 13 illustrates a virtualization environment in which functions implemented by some embodiments may be virtualized, according to certain embodiments;

FIG. 14 illustrates a host communicating via a network node with a UE over a partially wireless connection, according to certain embodiments;

FIG. 15 illustrates an example method by a UE, according to certain embodiments; and

FIG. 16 illustrates an example method by a network node, according to certain embodiments.

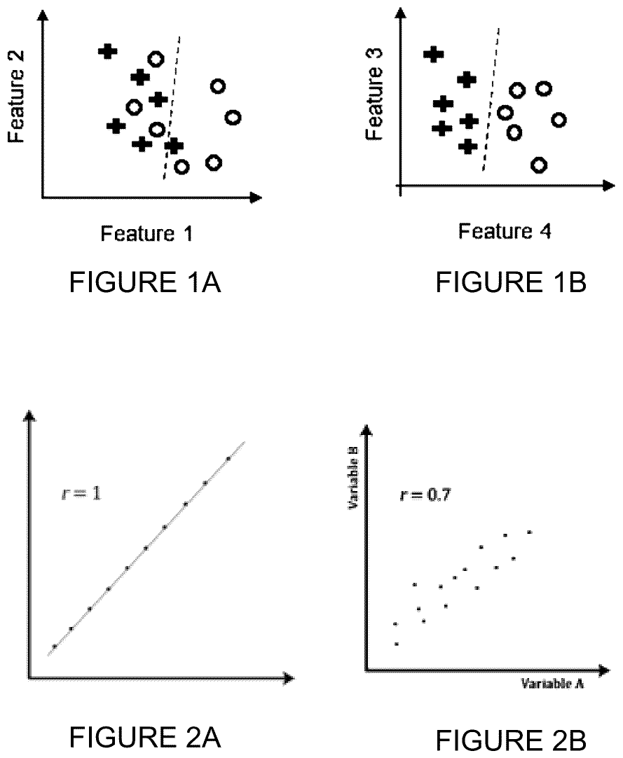

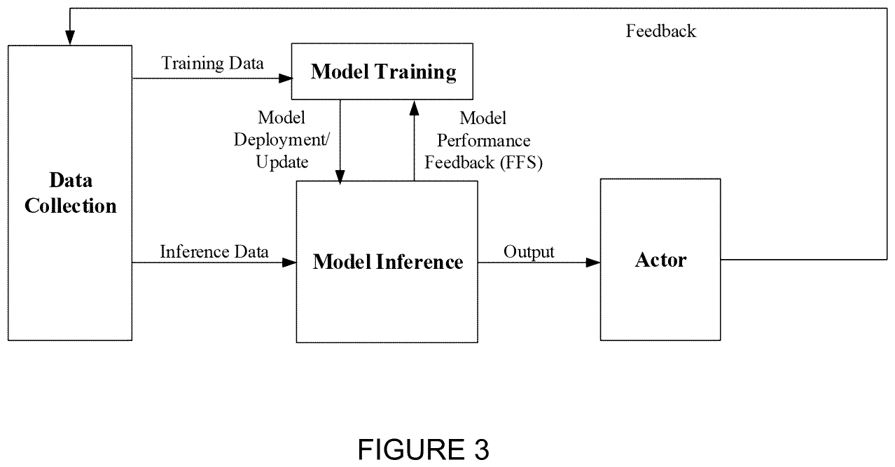

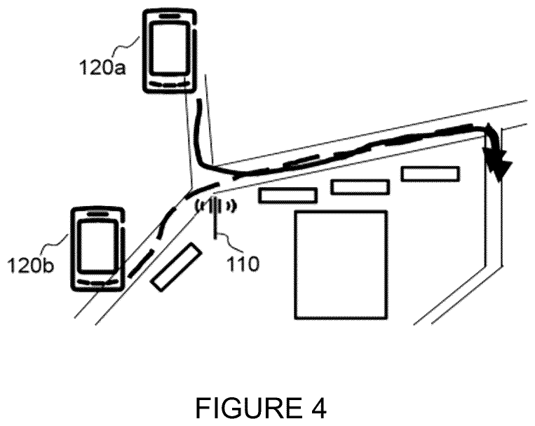

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

As used herein, the term “correlation” refers to a relation measure of two features and/or variables. It could also be seen as a similarity, or dependence among two variables. Likewise, the terms “correlated features”, “correlated metrics”, and “correlated response variables” are used when different values in a first such parameter consistently and predictably lead to differences in a second parameter and the value of the first parameter allows inferring the value (state, class, etc.) of the second parameter. As just one example, a first feature and a second feature may be considered correlated features when a value of the first feature consistently and predictably leads to difference in the second feature and the value of the first feature allows inferring the value of the second feature.

As used herein, the term “feature” refers to any measurement or value associated therewith that is performed and which may be correlated to any other measurement or value.

According to certain embodiments, methods and systems are provided for configuring devices to calculate and/or transmit assistance information that includes and/or indicates the correlation among potential features. Such information may be used by a network node to determine whether to build a certain ML model and the input features for said model. Additionally or alternatively, such information may be used to determine whether to use data and/or specific features from a given UE for training a ML model. The ML model can, for example, comprise of Beam Measurement prediction, carrier coverage prediction, signal quality forecast, radio-fingerprint based positioning, or other related methods.

For example, according to certain embodiments, a wireless device (such as, for example, a UE) is configured with a correlation estimation method. Specifically, a network node (e.g., gNB) may configure a wireless device (e.g., UE) to buffer (i.e., store) at least one measurement to be used for estimating the correlations with other measurements (including the response variable), in particular embodiments. Assistance information is then provided from the wireless device and can be used by the network to determine whether there are any meaningful correlation/similarity among various measurements (also denoted as features), whether to start training a certain ML-model, and for selecting the ML-model input features (i.e., a subset of the measurements). Note that when the wireless device performs correlations with the response variable, i.e. ML-model output, the wireless device may provide an indication of the feature importance for a certain measurement.

In various particular embodiments, the measurement(s) that may be performed by the wireless device may include any one or more of:
RSRP, SINR, RSRQ, delay spread, and/or angle-of-arrival on any of the defined reference signals in LTE/NR such as, for example:
   CSI-RS measurements,
   serving SSB measurements, and/or
   neighbour cell SSB measurements,
      Inter-freq. measurements,
      Intra-freq. Measurements,
timing advance values,
geolocation,
speed information,
IMU sensor data,
light sensor data (could be used to detect if UE is indoor/outdoor),
etc.

In a particular embodiment, for example, the network node may guide the wireless device to utilize existing measurements (e.g., normally configured CSI and beam management (BM) measurements) or extended configurations of such measurements (e.g., measurements on additional beams or higher-resolution CSI measurements), as enabled by a relevant existing cellular communication standard. Additionally or alternatively, in another particular embodiment, the wireless device may configure additional measurements, not supported by the standard but defined in proprietary specifications.

In a particular embodiment, the network node configures and/or provides a correlation estimation description that describes or indicates how the wireless device should process the logged values. For example, the correlation estimation description may include any one or more of:
A list of inputs to be used in the function, such as which measurements to be used when calculating the correlations, such as,
   Compute correlations between all measurements and a network node indicated response variable(s) (a subset of the measurements), or between measurement pairs
      Correlation may be computed such as, for example, as inner product of RSRP (or other quality metric) time series for a certain pair of SSB beams, time series of Signal Interference to Noise Ratio (SINR)/MI estimate for two CSI-RS beams, correlation of instantaneous power consumption pattern with a traffic arrival pattern or with receiver configuration, etc.
A function description
   Computing chi-squared test stats between each non-negative feature and class (response variable).
      Or, for example, Fisher exact test, especially if 2×2 problem space.
   Computing the Pearson Coefficient. Features with high correlation are more linearly dependent and when two features have high correlation, the ML model only needs to use one of the features, which can reduce the amount of signaling. The network node can select the threshold for the Pearson Coefficient to include a certain feature in the model based on the model accuracy requirements as described in subsequent text. The Pearson Coefficient can further be computed more efficiently by.
      Configuring the wireless device to use an online (windowed/sliding) method to estimate the Pearson coefficient, this enables the wireless device to not store an excessive amount of data.
      The network node could in another method to configure the mean value of each feature at the wireless device, based on history of information from previous wireless devices. This would reduce the need to buffer data at the wireless device.
   Computing the variance of a single measurement. This provides an estimate how much a single feature varies over time. For example, if a value is nearly constant, it indicates a low usability in adding it as an input to an ML model. One example could comprise of the wireless device timing advance in case the wireless device is having the constant timing advance value, it will not provide any useful information in the ML model (e.g. a model estimating the strongest beam).
   Computing the autocorrelation of certain measurement, the N-dimensional autocorrelation function (ACF) for N measurements/features.
   Computing correlation using Non-linear techniques such as the Maximal Information Coefficient (MIC) between two measurement variables; and/or
   Computing cosine similarity between two measurement variables.

In a particular embodiment, the feature correlation information configuration may be provided via Radio Resource Control (RRC) signaling from the network node to the wireless device.

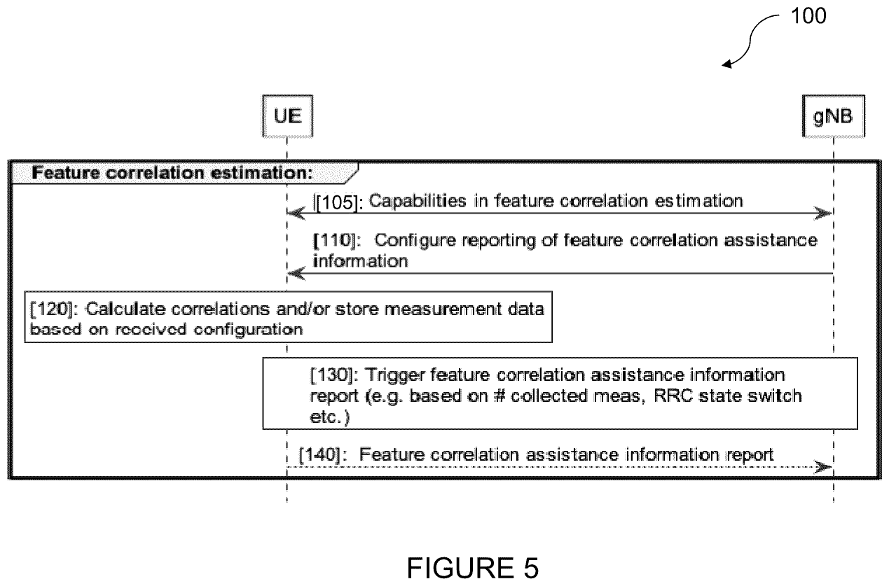

FIG. 5 illustrates an example method 100 by a wireless device for correlation estimation, according to certain embodiments. In the example method, the wireless device (e.g., UE) and network node (e.g., gNB) exchange capability information, at step 105. In a particular embodiment, for example, the wireless device may transmit an indication to the network node that the wireless device is capable of performing feature estimation. Such a message may be initiated by the wireless device autonomously or the network node may request such information from the wireless device.

At step 110, the network node transmits, to the wireless device, configuration information relating to the reporting of feature correlation assistance information by the wireless device.

At step 120, the wireless device calculates correlations and/or stores measurement data based on the configuration information received in step 110.

At step 130, a feature correlation assistance information report is triggered. Such a report may be based on a number of collected measures, a RRC state switch, or another triggering event.

In a particular embodiment, the decision as to when the wireless device should feedback the estimated correlation information can be based on a UE or network triggering criteria or triggering event. For example, according to various particular embodiments the triggering criteria or triggering event may include any one or more of the following:
when the wireless device changes RRC states (e.g., going from active to inactive or idle mode);
expiration of a period of time (e.g., the report may be a periodic report);
after a number of N measurements have been collected by the wireless device;
when memory buffer(s) of the wireless device, which is allocated for computing correlation estimates, is/are full;
when a gNB is configured to start its data collection for training an ML-model such as, for example, on a request from a second network node (e.g. MME, SME, OAM);
when the wireless device starts moving or when the wireless device changes location in the cell that exceeds more than a threshold;
when a triggering correlation value, according to the configuration, is observed; and/or
when a triggering change in the correlation value is observed.

In a particular embodiment, the wireless device performs correlation estimation regardless of the current reporting status. In another embodiment, the UE may perform correlation estimation when reporting is enabled. Otherwise, the correlation estimation may be omitted.

Returning to FIG. 5, the wireless device transmits the report to the network node at step 140. According to various embodiments, the report may include any one or more of the metrics described above with respect to step 110. In a particular embodiment, the network node may configure the wireless device to report the values above a certain threshold such that a sparser report is provided so as to reduce signaling overhead.

In a particular embodiment, for example, the wireless device transmits the feedback report, which includes the assistance information regarding feature correlations, via for example, a Physical Uplink Control Channel (PUCCH) (if the report size is moderate), or via RRC signaling (if the report size is large.) In one embodiment, if the wireless device has performed correlation analysis while in idle/inactive states, the wireless device may provide the assistance info next occasion when in connected mode.

In a particular embodiment, the network node may use the population-wide correlation reports of the wireless device to select a preferred feature set and, in their configurations, request all wireless devices to report these features. In another embodiment, the network node may determine preferred features on a per-UE basis and request individual wireless devices to report their individually preferred features, e.g. with high feature-result correlation or with low feature-feature correlation.

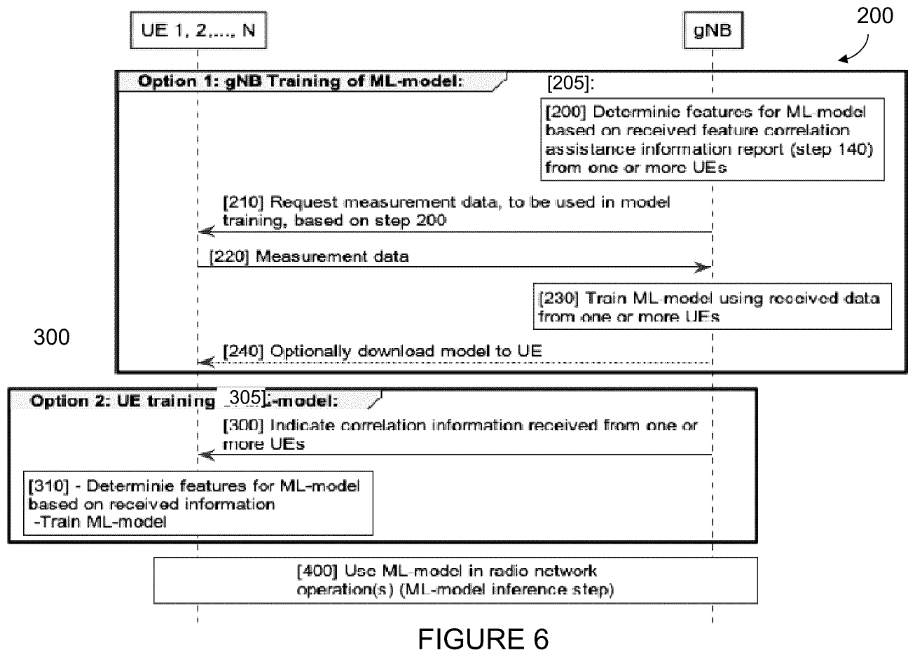

After the network node receives the correlation assistance information from the wireless device, the correlation assistance information is used to train a ML model. FIG. 6 illustrates example methods 200 and 300 by a network node (e.g., gNB) and wireless device (e.g., UE), respectively, for training a ML model, according to certain embodiments.

Specifically, according to a first option, which relates a method 200 for training of the ML model by the network node, the network node determines features for at least one ML-model. The features may be determined based on the correlation assistance information received from one or more wireless devices, at step 205. For example, it could be the features with high correlation to the response variable. Additionally, it could comprise features with a low correlation to all other potential features, i.e. features with a high correlation to selected features can be omitted without compromising training performance. The network node may combine the reported correlation for the set of wireless devices by, estimating the mean/max/min of the correlations.

The number of features could be selected based of the performance requirements of the ML-model, or memory constraints at the network.

At step 210, the network node transmits, to a wireless device, a request for measurement data to be used in model training. In a particular embodiment, the request for the measurement data may be based on the determining step 200. Thus, the network node requests the UE to start measuring and report the selected features.

At step 220, the wireless devices transmits the measurement data. Thereafter, the network node trains the ML-model using the received data from the one or more wireless devices, at step 230.

According to a second option, which relates a method 300 for training of the ML model by the wireless device, the correlations metrics are signaled to the one or more wireless devices (or part of TCI, QCL type of information defined in NR), at step 305. Thus, the correlations metrics may be used by the wireless device(s) as a decision criterion to create their own respective ML models. For example, at step 310, the wireless device determines features for ML-model based on the information received from the network node.

In a particular embodiment, for example, the wireless devices creates a certain mapping of signal qualities. The wireless device may decide to create an ML model to predict a first beam if it is correlated with a certain threshold value to second beam, for example. This could be useful for a stationary wireless device or a wireless device that frequently visits a certain area (travels frequently on a certain path), for example.

In a particular embodiment, the correlation score could also indicate the number of measurements the wireless device needs to retrieve to build an accurate model. A high correlation can indicate that the wireless device can, for example, only retrieve a small number of measurements, in order to predict a second measurement based on a first measurement. This situation of high correlation can for example occur in the case for a multi-frequency deployment, where the different carrier frequencies for co-located transmission points have a signal quality offset depending on the carrier frequency. For example, the RSRP of one beam is always x dBm lower.

At step 400, either or both of the wireless device(s) and/or the network node may use the ML-model in radio network operation(s).

### Data Drift Detection

In a particular embodiment, to aid data drift detection of the trained AI model at the network node, the wireless device is configured to send a measurement report based on a trigger condition. For example, in a further particular embodiment, the trigger condition may be that the wireless device has two or more correlated parameters that are outside of an operational range that is configured by the network. Further, the measurement that is basis for the triggering condition may also be done sparsely to not require the UE to do frequent measurements, in a particular embodiment.

In a particular embodiment, the network node can further configure different correlation estimation request to different UEs, in order to reduce the overhead for one, or a few set of devices for detecting a potential data drift.

Another possibility of drift detection is that the network node detects that the performance is below a certain threshold. Further details on how this can be defined for a use case is described further below. In a particular embodiment, the network node may not have a complete picture in what causes the performance to be below a certain threshold and, therefore, configures the above-described procedure. Alternatively, the network node configures the above-described procedure for one, a subset, or all the UEs that it is/are operating.

In a particular embodiment, if the network node has detected that the model is no longer functioning within a threshold, the network node may revert to operate without the current ML-model. The alternative could be to revert back to previous ML-model or to non-ML-model based operation.

In a particular embodiment, the network node further triggers collection of new training data from one or multiple wireless devices to be able to retrain its ML-model. By that creating a new ML-model that would function with performance above a certain threshold.

### Radio Networking Operation Using ML Models

After the completion of model training, the model may be used (by either or both of the network node and wireless device) to improve beamforming operations, carrier selections, link adaptation, etc. As mentioned above, ML model performance is continuously monitored at the network node, in a particular embodiment. For example, the network node may monitor ML model performance to detect if the model performance drops in respect to the performance seen during training.

In a particular embodiment, the ability to forecast the signal quality is not as accurate during the training phase. Accordingly, in a particular embodiment, the network node then requests for new correlation estimation data from the wireless devices in order to collect new important features prior to collect a new set of data.

### UE Capabilities

Some wireless devices might support different correlation determination schemes, in certain embodiments. In a particular embodiment, for example, the UE signals its capabilities to the network node. The network node may then select a proper model based on the UE capability report. In various particular embodiments, the capabilities of the wireless device may include, for example, any one or more of:
UE manufacturer;
UE type, e.g., Ultra Reliable Low Latency Communication (URLLC), Enhanced Mobile Broadband (eMBB), Reduced Capability (Redcap), XR, etc.;
Maximum consumed memory of model;
Floating point support, (e.g., 8-bit/16-bit/32-bit float);
Number of feature/parameter pairs for which correlation analysis may be performed; and
Observation durations (time series length) for parameters.

### Use Cases

Certain embodiments described herein may exemplified with two use cases. In the examples, the wireless device has collected a set of measurements, which have not been transmitted to the network node to limit the signalling overhead. For example, the wireless device may only transmit the RSRP for the strongest beam, or the SINR with a certain granular periodicity for the forecasting example.

### Beam Prediction

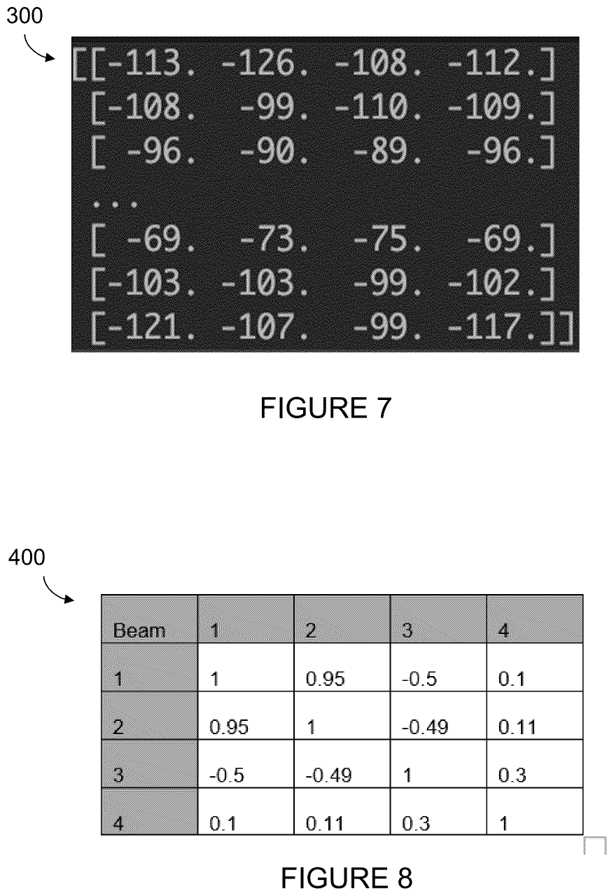

FIG. 7 illustrates an example scenario where the wireless device first collects a set of UE measurements 300 comprising RSRP data for 4 SSB-beams transmitted by the network node. Stated differently, FIG. 7 illustrates example data collected on 4 different SSB-beams.

The wireless device then calculates the correlation among the different beams. In a particular embodiment, the wireless device generates a Pearson Coefficient matrix for each pair. FIG. 8 illustrates an example Pearson coefficient matrix 400, according to certain embodiments. Specifically, the Pearson coefficient matrix 400 shows how the beams 1 & 2 are highly correlated. This could, for example, be used to build a beam predictor for the second beam (beam ID 2) using the first beam (beam ID 1) measurements. There is no need to configure the device to report the second beam since it is made almost redundant by the first beam due to the high correlations. Note that the conclusion may be unique to the UE in its current position, as other UEs may experience different beam 1-2 and beam 3-4 relations.

In a particular embodiment, for data drift detection for beam prediction and beam forecasting, the network node measures the amount of beam failure reports received. If the number of reports for specific beams or all beams are above a certain threshold, the network node may conclude that the ML-model for beam forecasting or beam prediction is not function adequately. Based on that, the network node may either directly trigger a retraining of ML-model(s) or configure a set of UEs with a report with trigger conditions as described above. If the network node concludes a new distribution on of the data based on the UE report(s), the network node then triggers a retraining of the ML-model(s), according to certain embodiments.

### Beam Forecast

A time series of measurements could be used to calculate the autocorrelation, assuming a UE has calculated ACF for a certain beam SINR. TABLE 1 shows how the correlation decreases with the time-lag, and the goes up in lag 6. This could indicate a periodical blocker in an area, in a particular embodiment. Additionally or alternatively, this may indicate an interference source with a certain periodicity. It could comprise of another TDD configuration or a certain beam sweeping in a neighbor that causes a static interference, in certain timeframes. This could be used to train a model at the network to take such into account when doing link adaptation. For example, it is hard to predict for time lags 3-4-5, but easier to create a forecaster for time-lag 1,2,6.

TABLE 1

| | | | | | | | |
|---|---|---|---|---|---|---|---|
| Normalized | 1 | 0.9 | 0.8 | 0.3 | −0.2 | 0.1 | 0.8 |
| autocorrelation | | | | | | | |
| Time-lag | 0 | 1 | 2 | 3 | 4 | 5 | 6 |

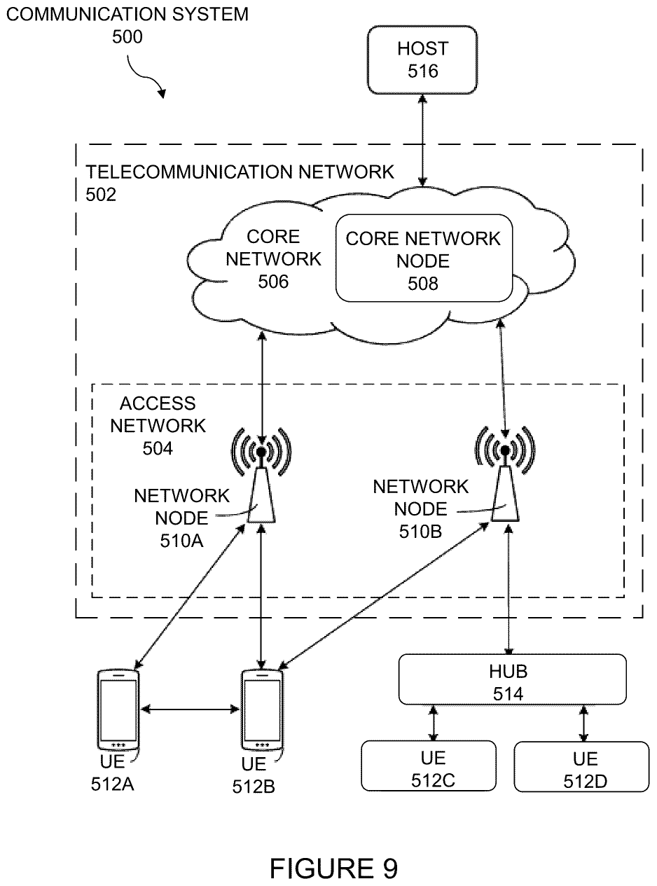

FIG. 9 shows an example of a communication system 500 in accordance with some embodiments.

In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3^{rd} Generation Partnership Project (3GPP) access node or non-3GPP access point. The network nodes 510 facilitate direct or indirect connection of user equipment (UE), such as by connecting UEs 512a, 512b, 512c, and 512d (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 514 communicates with the access network 504 to facilitate indirect communication between one or more UEs (e.g., UE 512c and/or 512d) and network nodes (e.g., network node 510b). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub—that is, a hub whose primary function is to route communications to/from the UEs from/to the network node 510b. In other embodiments, the hub 514 may be a non-dedicated hub—that is, a device which is capable of operating to route communications between the UEs and network node 510b, but which is additionally capable of operating as a communication start and/or end point for certain data channels.

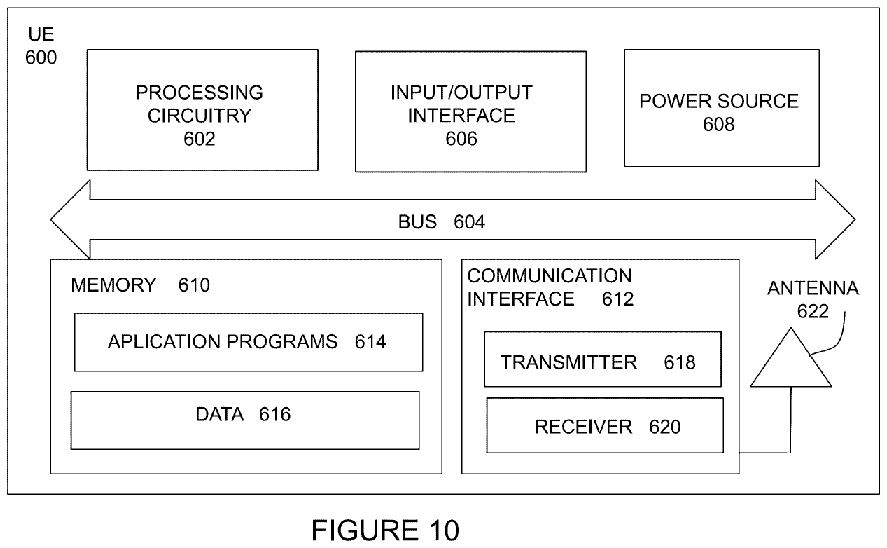

FIG. 10 shows a UE 600 in accordance with some embodiments.

As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, a memory 610, a communication interface 612, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In the illustrated embodiment, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

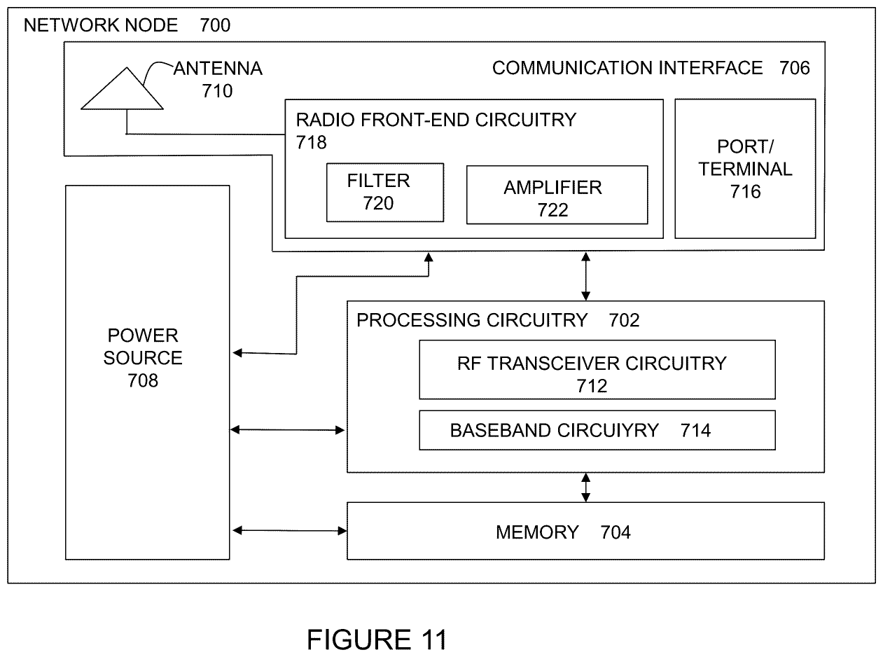

FIG. 11 shows a network node 700 in accordance with some embodiments.

As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes a processing circuitry 702, a memory 704, a communication interface 706, and a power source 708. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, to provide network node 700 functionality.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710 and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 11 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

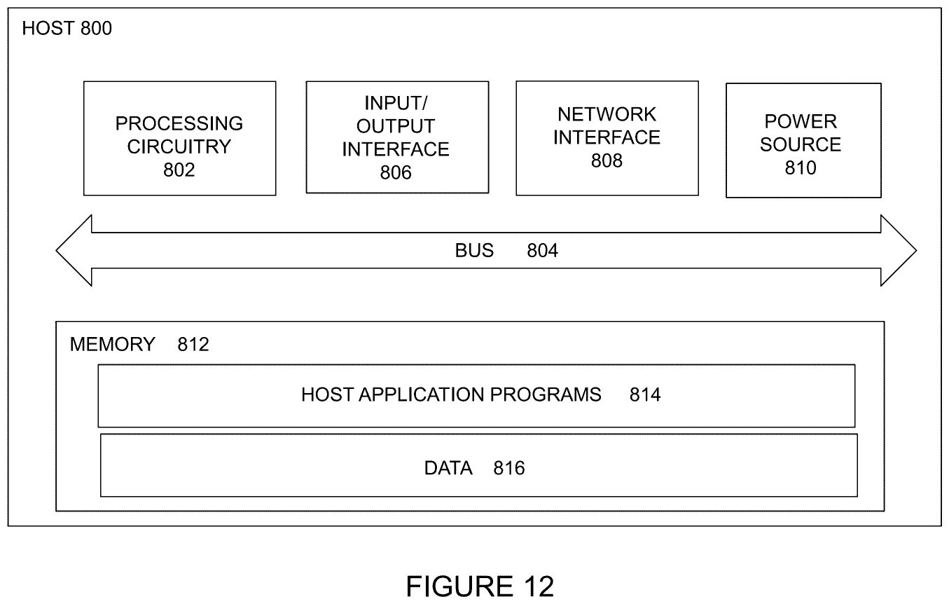

FIG. 12 is a block diagram of a host 800, which may be an embodiment of the host 516 of FIG. 9, in accordance with various aspects described herein.

As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

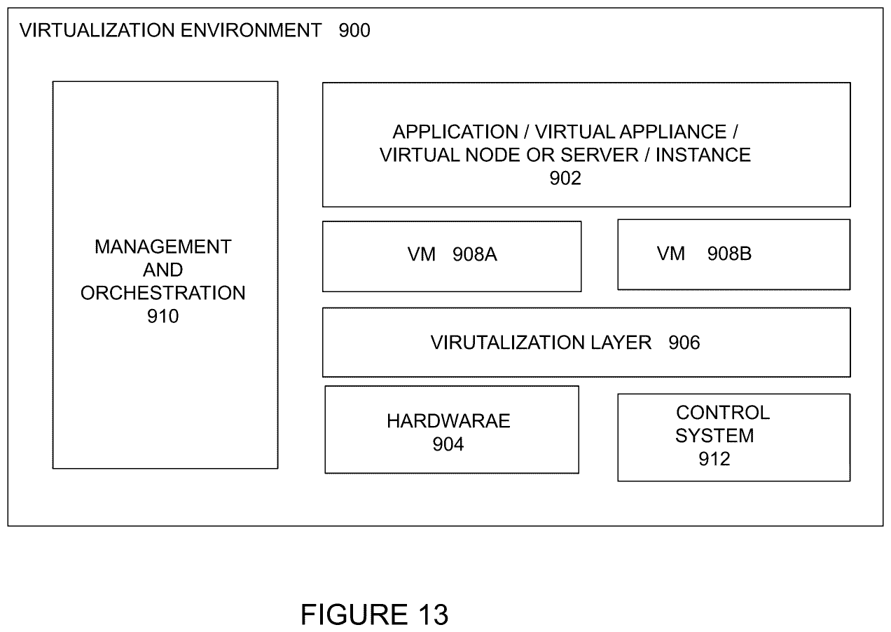

FIG. 13 is a block diagram illustrating a virtualization environment 900 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

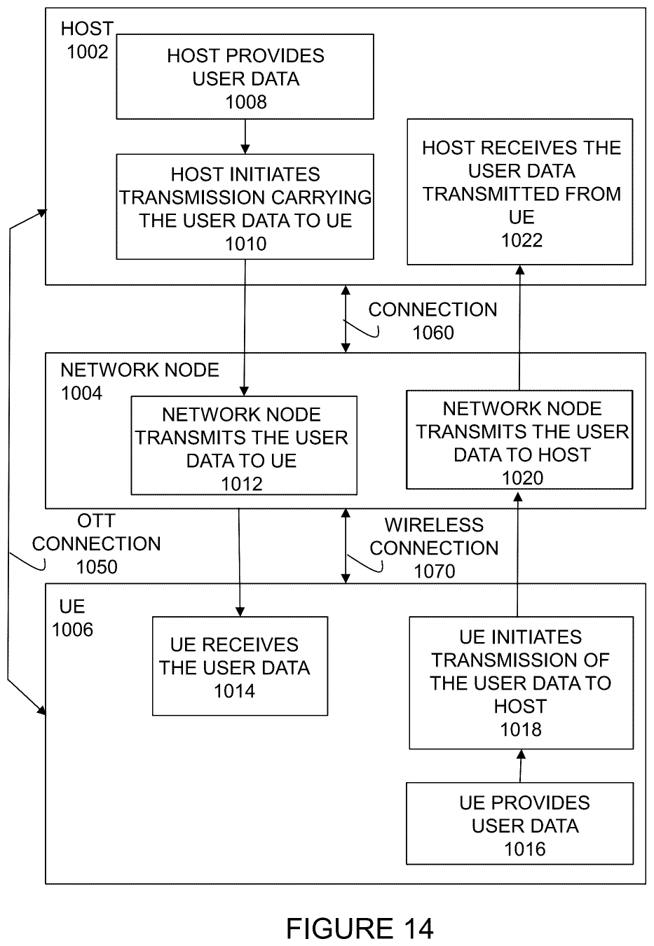

FIG. 14 shows a communication diagram of a host 1002 communicating via a network node 1004 with a UE 1006 over a partially wireless connection in accordance with some embodiments.

Example implementations, in accordance with various embodiments, of the UE (such as a UE 512a of FIG. 9 and/or UE 600 of FIG. 10), network node (such as network node 510a of FIG. 9 and/or network node 700 of FIG. 11), and host (such as host 516 of FIG. 9 and/or host 800 of FIG. 12) discussed in the preceding paragraphs will now be described with reference to FIG. 14.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 9) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

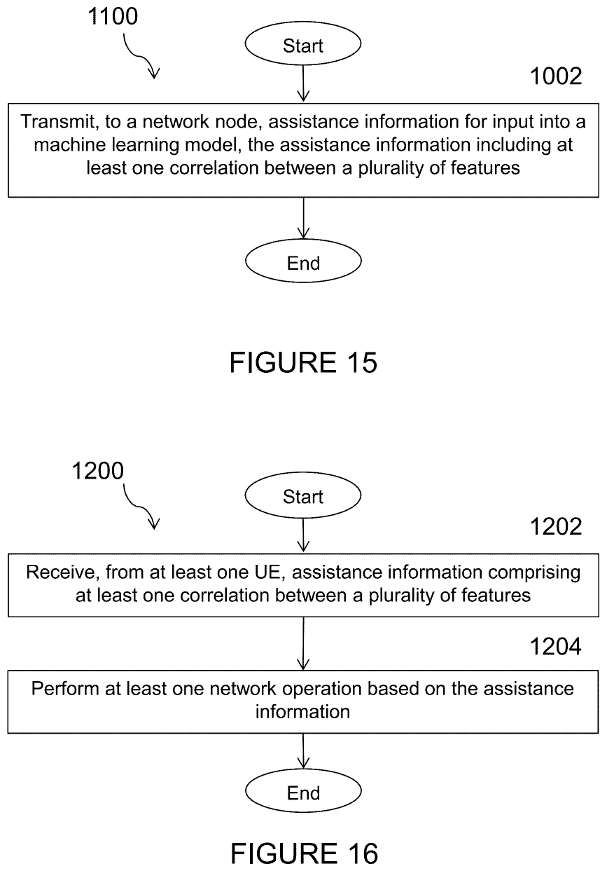

FIG. 15 illustrates a method 1100 performed by a UE for assisted feature correlation estimation, according to certain embodiments. The method includes, at step 1102, transmitting, to a network node, assistance information for input into a ML model. The assistance information includes at least one correlation between a plurality of features.

In a particular embodiment, the plurality of features include at least a first feature and a second feature, and the at least one correlation is a relation measured between the first feature and the second feature.

In a particular embodiment, the assistance information includes a plurality of values, and each one of the plurality of values measures a relation between at least two of the plurality of features.

In a particular embodiment, the method includes determining that each of the plurality of values is greater than a minimum threshold.

In a particular embodiment, the UE performs at least one measurement, stores at least one value associated with each one of the at least one measurements that are performed, and determines and/or calculates the at least one correlation between the plurality of features based on the at least one measurement.

In a particular embodiment, a feature optionally comprises and/or corresponds to at least one measurement at a time instance. For example, a first feature may include a value associated with a RSRP measurement at a first time instance (i.e., t=0) and a second feature may include a value associated with a RSRP measurement at a second time instance (i.e., t=1).

In a particular embodiment, the at least one measurement comprises at least one of: a RSRP measurement; a SINR measurement; a RSRQ measurement; a delay spread measurement; an angle of arrival measurement; a TA; geolocation information; speed information; an IMU sensor data; and a light sensor data.

In a particular embodiment, the UE receives, from the network node, an indication of at least one subset of the plurality of features and performs at least one additional measurement for the at least one subset of the plurality of features.

In a particular embodiment, the UE determines that at least one reporting condition is fulfilled, wherein the assistance information is transmitted to the network node based on the at least one reporting condition being fulfilled.

In a further particular embodiment, the determination that the at least one reporting condition is fulfilled is based on at least one of: detecting a change in a Radio Resource Control state at the UE (e.g., idle or inactive mode to active mode); detecting an expiration of a time period for periodically reporting the assistance information; performing a number of measurements that is greater than a threshold; determining that a memory buffer storing the assistance information is full; determining that a number of measurements is outside an acceptable operational range; receiving a request from the network node; determining a change in location and/or determining a change in a cell of the UE; computing a correlation value that is associated with the at least one reporting condition; and detecting a change in a correlation value that greater than a threshold.

In a particular embodiment, the UE transmits, to the network node, information indicating a capability of the UE to perform feature correlation estimation and/or a capability of the UE to provide the assistance information.

In a particular embodiment, the UE receives, from the network node, information indicating a capability of the network node to receive the assistance information.

In a particular embodiment, the UE receives, from the network node, a configuration for performing correlation estimation between the plurality of features.

In a particular embodiment, the configuration includes the at least one reporting condition.

In a particular embodiment, the configuration includes a correlation estimation description, and the correlation estimation description includes a list of one or more inputs to be used in a function for determining the at least one correlation.

In a particular embodiment, the configuration includes a function description for determining a function for determining the at least one correlation, and the function is associated with at least one of: computing at least one chi-squared test stat between at least two features; computing a Pearson-coefficient between at least two features; computing a variance of a feature; computing an autocorrelation of a feature; computing a correlation using non-linear techniques between at least two features; and computing a cosine similarity between at least two features.

In a particular embodiment, the UE receives, from the network node, a ML model that is at least partially based on the assistance information and uses the ML model to perform at least one operation.

In a particular embodiment, using the ML model to perform the at least one operation comprises at least one of: inferring the value of the first feature based on the value of the second feature; predicting a strength or quality of a beam; selecting a reference signal for performing at least one measurement; determining not to perform at least one measurement; and predict a change in a signal quality.

In a particular embodiment, the UE receives, from the network node, correlation information associated with one or more other UEs and determines, based on the correlation information associated with the one or more other UEs, at least one input feature for a ML model received from the network node or generated by the UE.

In a particular embodiment, the UE provides user data and forwards the user data to a host via the transmission to the network node.

FIG. 16 illustrates an example method 1200 performed by a network node for assisted feature correlation estimation, according to certain embodiments. The method includes, at step 1202, receiving, from at least one UE, assistance information comprising at least one correlation between a plurality of features. At step 1204, the network node performs at least one network operation based on the assistance information.

In a particular embodiment, the plurality of features include at least a first feature and a second feature, and the at least one correlation is a relation measured between the first feature and the second feature.

In a particular embodiment, the assistance information includes a plurality of values, and each one of the plurality of values measures a relation between at least two of the plurality of features.

In a particular embodiment, the method includes determining that each of the plurality of values is greater than a minimum threshold.

In a particular embodiment, the at least one correlation between the plurality of feature is based on at least one measurement performed by the at least one UE.

In a particular embodiment, a feature optionally comprises and/or corresponds to at least one measurement at a time instance. For example, a first feature may include a value associated with a RSRP measurement performed by the at least one UE at a first time instance (i.e., t=0) and a second feature may include a value associated with a RSRP measurement performed by the at least one UE at a second time instance (i.e., t=1).

In a further particular embodiment, the at least one measurement comprises at least one of: a RSRP measurement; a SINR measurement; a RSRQ measurement; a delay spread measurement; an angle of arrival measurement; aTA; geolocation information; speed information; IMU sensor data; and light sensor data.

In a particular embodiment, when performing the at least one network operation, the network node determines, based on the assistance information, at least one subset of the plurality of features and transmits, to the at least one UE, an indication of the at least one subset of the plurality of features.

In a particular embodiment, the network node transmits, to the at least one UE, an indication of at least one reporting condition to be fulfilled before the assistance information is transmitted to the network node.

In a particular embodiment, the at least of reporting condition is fulfilled when at least one of: a change in a Radio Resource Control state is detected at the at least one UE (e.g., idle or inactive mode to active mode); a time period for periodically reporting the assistance information expires; a number of performed measurements is greater than a threshold; a memory buffer storing the assistance information at the at least one UE is full; a number of measurements is outside an acceptable operational range; a request is transmitted to the at least one UE from the network node; the UE changes location and/or cells; a correlation value is detected that is associated with the at least one reporting condition; and a change in a correlation value is greater than a threshold.

In a particular embodiment, the network node receives, from the at least one UE, information indicating at least one of: a capability of the at least one UE to perform feature correlation estimation and/or a capability of the at least one UE to provide the assistance information.

In a particular embodiment, the network node transmits, to the at least one UE, information indicating a capability of the network node to receive the assistance information.

In a particular embodiment, the network node transmits, to the at least one UE, a configuration for performing correlation estimation between the plurality of features.

In a further particular embodiment, the configuration includes the at least one reporting condition.

In a particular embodiment, the configuration includes a correlation estimation description, the correlation estimation description comprising a list of one or more inputs to be used in a function for determining the at least one correlation.

In a particular embodiment, the configuration includes a function description for determining, by the at least one UE, a function for calculating the at least one correlation. The function is associated with at least one of: computing at least one chi-squared test stat between at least two features; computing a Pearson-coefficient between at least two features; computing a variance of a measurement; computing an autocorrelation of a measurement; computing a correlation using non-linear techniques; and computing a cosine similarity between at least two features.

In a particular embodiment, performing the at least one network operation comprises at least one of: determining, based on the assistance information, at least one of the plurality of features to use as input for a ML model; training a model to predict the value of the first feature based on the value of the second feature; training a model to predict a strength or quality of a beam; training a model to selecting a reference signal for performing at least one measurement; training a model to determining not to perform at least one measurement; and training a model to predict a change in a signal quality.

In a particular embodiment, training a model can include a prior step of data collection, based on the selected features.

In a particular embodiment, performing the at least one network operation comprises: determining, based on the assistance information, at least one of the plurality of features to use as input for a ML model; and based on the input, using the ML model to perform at least one of: infer the value of the first feature based on the value of the second feature; predict a strength or quality of a beam; select a reference signal for performing at least one measurement; determine not to perform at least one measurement; and predict a change in a signal quality.

In a further particular embodiment, the network node transmits, to the at least one UE, the ML model.

In a particular embodiment, assistance information is received from a plurality of UEs. The network node transmits, to at least a first one of the plurality of UEs, the assistance information received from at least a second one of the plurality of UEs.

In a particular embodiment, the network node comprises a gNB.

In a particular embodiment, the network node obtains user data and forwards the user data to a host or a UE.

### EXAMPLE EMBODIMENTS OF THE DISCLOSURE

### Group A Example Embodiments

Example Embodiment A1. A method performed by a user equipment for assisted feature correlation estimation, the method comprising: any of the user equipment steps, features, or functions described above, either alone or in combination with other steps, features, or functions described above.

Example Embodiment A2. The method of Example Embodiments A1, further comprising one or more additional user equipment steps, features or functions described above.

Example Embodiment A3. The method of any one of Example Embodiments A1 or A2, further comprising: providing user data; and forwarding the user data to a host computer via the transmission to the network node.

### Group B Example Embodiments

Example Embodiment B1. A method performed by a network node for assisted feature correlation estimation the method comprising: any of the network node steps, features, or functions described above, either alone or in combination with other steps, features, or functions described above.

Example Embodiment B2. The method of Example Embodiments B1, further comprising one or more additional network node steps, features or functions described above.

Example Embodiment B3. The method of any one of Example Embodiments B1 or B2, further comprising: obtaining user data; and forwarding the user data to a host or a user equipment.

### Group C Example Embodiments

Example Embodiment C1. A method performed by a user equipment (UE) for assisted feature correlation estimation, the method comprising: transmitting, to a network node, assistance information for input into a ML model, the assistance information comprising at least one correlation between a plurality of features.

Example Embodiment C2. The method of Example Embodiment C1, further comprising: performing at least one measurement; storing at least one value associated with each one of the at least one measurements that are performed; and determining and/or calculating the at least one correlation between the plurality of features based on the at least one measurement.

Example Embodiment C3. The method of Example Embodiment C2, wherein the at least one measurement comprises at least one of: a RSRP measurement; a SINR measurement; a RSRQ measurement; a delay spread measurement; an angle of arrival measurement; a timing advance measurement; a geolocation measurement; a speed measurement; an IMU sensor data measurement; and a light sensor data measurement.

Example Embodiment C4. The method of any one of Example Embodiments C2 to C3, further comprising: receiving, from the network node, an indication of at least one subset of the plurality of features and performing at least one additional measurement for the at least one subset of the plurality of features.

Example Embodiment C5. The method of any one of Example Embodiments C1 to C4, further comprising determining that at least one reporting condition is fulfilled, wherein the assistance information is transmitted to the network node based on the at least one reporting condition being fulfilled.

Example Embodiment C6. The method of Example Embodiment C5, wherein determining that the at least one reporting condition is fulfilled is based on at least one of: detecting a change in a Radio Resource Control state at the UE (e.g., idle or inactive mode to active mode); detecting an expiration of a time period for periodically reporting the assistance information; performing a number of measurements that is greater than a threshold; determining that a memory buffer storing the assistance information is full; determining that a number of measurements is outside an acceptable operational range; receiving a request from the network node; determining a change in location and/or determining a change in a cell of the UE; computing a correlation value that is associated with the at least one reporting condition; and detecting a change in a correlation value that greater than a threshold.

Example Embodiment C7. The method of any one of Example Embodiments C1 to C6, wherein the plurality of features comprise at least a first feature and a second feature, and wherein the at least one correlation comprises a relation measured between the first feature and the second feature.

Example Embodiment C8. The method of any one of Example Embodiments C1 to C7, wherein the assistance information comprises a plurality of values, each one of the plurality of values measuring a relation between at least two of the plurality of features.

Example Embodiment C9. The method of Example Embodiment C8, further comprising determining that each of the plurality of values is greater than a minimum threshold.

Example Embodiment C10. The method of any one of Example Embodiments C1 to C9, further comprising transmitting, to the network node, information indicating a capability of the UE to perform feature correlation estimation and/or a capability of the UE to provide the assistance information.

Example Embodiment C11. The method of any one of Example Embodiments C1 to C10, further comprising receiving, from the network node, information indicating a capability of the network node to receive the assistance information.

Example Embodiment C12. The method of any one of Example Embodiments C1 to C11, further comprising receiving, from the network node, a configuration for performing correlation estimation between the plurality of features.

Example Embodiment C13. The method of Example Embodiment C12, wherein the configuration comprises the at least one reporting condition.

Example Embodiment C14. The method of any one of Example Embodiments C12 to C13, wherein the configuration comprises a correlation estimation description, the correlation estimation description comprising a list of one or more inputs to be used in a function for determining the at least one correlation.

Example Embodiment C15. The method of any one of Example Embodiments C12 to C14, wherein the configuration comprises a function description for determining a function for determining the at least one correlation, wherein the function is associated with at least one of: computing at least one chi-squared test stat between at least two features; computing a Pearson-coefficient between at least two features; computing a variance of a measurement; computing an autocorrelation of a measurement; computing a correlation using non-linear techniques; and computing a cosine similarity between at least two features.

Example Embodiment C16. The method of any one of Example Embodiments C1 to C15, further comprising: receiving, from the network node, a ML model that is at least partially based on the assistance information; and using the ML model to perform at least one operation.

Example Embodiment C17. The method of Example Embodiment C16, wherein using the ML model to perform the at least one operation comprises at least one of: inferring the value of the first feature based on the value of the second feature; predicting a strength or quality of a beam; selecting a reference signal for performing at least one measurement; determining not to perform at least one measurement; and predict a change in a signal quality.

Example Embodiment C18. The method of any one of Example Embodiments C1 to C17, further comprising: receiving, from the network node, correlation information associated with one or more other UEs; and determining, based on the correlation information associated with the one or more other UEs, at least one input feature for a ML model received from the network node or generated by the UE.

Example Embodiment C19. The method of Example Embodiments C1 to C18, further comprising: providing user data; and forwarding the user data to a host via the transmission to the network node.

Example Embodiment C20. A user equipment comprising processing circuitry configured to perform any of the methods of Example Embodiments C1 to C19.

Example Embodiment C21. A wireless device comprising processing circuitry configured to perform any of the methods of Example Embodiments C1 to C19.

Example Embodiment C22. A computer program comprising instructions which when executed on a computer perform any of the methods of Example Embodiments C1 to C19.

Example Embodiment C23. A computer program product comprising computer program, the computer program comprising instructions which when executed on a computer perform any of the methods of Example Embodiments C1 to C19.

Example Embodiment C24. A non-transitory computer readable medium storing instructions which when executed by a computer perform any of the methods of Example Embodiments C1 to C19.

### Group D Example Embodiments

Example Embodiment D1. A method performed by a network node for assisted feature correlation estimation the method comprising: receiving, from at least one user equipment (UE), assistance information comprising at least one correlation between a plurality of features; and performing at least one network operation based on the assistance information.

Example Embodiment D2. The method of Example Embodiment C1, wherein the at least one correlation between the plurality of feature is based on at least one measurement performed by the at least one UE.

Example Embodiment D3. The method of Example Embodiment D2, wherein the at least one measurement comprises at least one of: a RSRP measurement; a SINR measurement; a RSRQ measurement; a delay spread measurement; an angle of arrival measurement; a timing advance measurement; a geolocation measurement; a speed measurement; an IMU sensor data measurement; and a light sensor data measurement.

Example Embodiment D4. The method of any one of Example Embodiments D2 to D3, wherein performing the at least one network operation comprises: determining, based on the assistance information, at least one subset of the plurality of features; and transmitting, to the at least one UE, an indication of the at least one subset of the plurality of features.

Example Embodiment D5. The method of any one of Example Embodiments D1 to D4, further comprising transmitting, to the at least one UE, an indication of at least one reporting condition to be fulfilled before the assistance information is transmitted to the network node.

Example Embodiment D6. The method of Example Embodiment D5, wherein the at least of reporting condition is fulfilled when at least one of: a change in a Radio Resource Control state is detected at the at least one UE (e.g., idle or inactive mode to active mode); a time period for periodically reporting the assistance information expires; a number of performed measurements is greater than a threshold; a memory buffer storing the assistance information at the at least one UE is full; a number of measurements is outside an acceptable operational range; a request is transmitted to the at least one UE from the network node; the UE changes location and/or cells; a correlation value is detected that is associated with the at least one reporting condition; and a change in a correlation value is greater than a threshold.

Example Embodiment D7. The method of any one of Example Embodiments D1 to D6, wherein the plurality of features comprise at least a first feature and a second feature, and wherein the at least one correlation comprises a relation measured between the first feature and the second feature.

Example Embodiment D8. The method of any one of Example Embodiments D1 to D7, wherein the assistance information comprises a plurality of values, each one of the plurality of values measuring a relation between at least two of the plurality of features.

Example Embodiment D9. The method of Example Embodiment D8, wherein each of the plurality of values is greater than a minimum threshold.

Example Embodiment D10. The method of any one of Example Embodiments D1 to D9, further comprising receiving, from the at least one UE, information indicating a capability of the at least one UE to perform feature correlation estimation and/or a capability of the at least one UE to provide the assistance information.

Example Embodiment D11. The method of any one of Example Embodiments D1 to D10, further comprising transmitting, to the at least one UE, information indicating a capability of the network node to receive the assistance information.

Example Embodiment D12. The method of any one of Example Embodiments D1 to D11, further comprising transmitting, to the at least one UE, a configuration for performing correlation estimation between the plurality of features.

Example Embodiment D13. The method of Example Embodiment D12, wherein the configuration comprises the at least one reporting condition.

Example Embodiment D14. The method of any one of Example Embodiments D12 to D13, wherein the configuration comprises a correlation estimation description, the correlation estimation description comprising a list of one or more inputs to be used in a function for determining the at least one correlation.

Example Embodiment D15. The method of any one of Example Embodiments D12 to D14, wherein the configuration comprises a function description for determining, by the at least one UE, a function for calculating the at least one correlation, wherein the function is associated with at least one of: computing at least one chi-squared test stat between at least two features; computing a Pearson-coefficient between at least two features; computing a variance of a measurement; computing an autocorrelation of a measurement; computing a correlation using non-linear techniques; and computing a cosine similarity between at least two features.

Example Embodiment D16. The method of any one of Example Embodiments D1 to D15, wherein performing the at least one network operation comprises at least one of: determining, based on the assistance information, at least one of the plurality of features to use as input for a ML model; and training a model to predict the value of the first feature based on the value of the second feature; training a model to predict a strength or quality of a beam; training a model to selecting a reference signal for performing at least one measurement; training a model to determining not to perform at least one measurement; and training a model to predict a change in a signal quality.

Example Embodiment D17. The method of any one of Example Embodiments D16, wherein training a model can include a prior step of data collection, based on the selected features.

Example Embodiment D18. The method of any one of Example Embodiments D1 to D17, wherein performing the at least one network operation comprises: determining, based on the assistance information, at least one of the plurality of features to use as input for a ML model; and based on the input, using the ML model to perform at least one of: infer the value of the first feature based on the value of the second feature; predict a strength or quality of a beam; select a reference signal for performing at least one measurement; determine not to perform at least one measurement; and predict a change in a signal quality.

Example Embodiment D19. The method of Example Embodiment D18, further comprising transmitting, to the at least one UE, the ML model.

Example Embodiment D20. The method of any one of Example Embodiments D1 to D19, wherein assistance information is received from a plurality of UEs, the method further comprising: transmitting, to at least a first one of the plurality of UEs, the assistance information received from at least a second one of the plurality of UEs.

Example Embodiment D21. The method of any one of Example Embodiments D1 to D20, wherein the network node comprises a gNodeB (gNB).

Example Embodiment D22. The method of any of Example Embodiments D1 to D21, further comprising: obtaining user data; and forwarding the user data to a host or a user equipment.

Example Embodiment D23. A network node comprising processing circuitry configured to perform any of the methods of Example Embodiments D1 to D22.

Example Embodiment D24. A computer program comprising instructions which when executed on a computer perform any of the methods of Example Embodiments D1 to D22.

Example Embodiment D25. A computer program product comprising computer program, the computer program comprising instructions which when executed on a computer perform any of the methods of Example Embodiments D1 to D22.

Example Embodiment D26. A non-transitory computer readable medium storing instructions which when executed by a computer perform any of the methods of Example Embodiments D1 to D22.

### Group E Example Embodiments

Example Embodiment E1. A user equipment (UE) for assisted feature correlation estimation, the UE comprising: processing circuitry configured to perform any of the steps of any of the Group A and C Example Embodiments; and power supply circuitry configured to supply power to the processing circuitry.

Example Embodiment E2. A network node for assisted feature correlation estimation, the network node comprising: processing circuitry configured to perform any of the steps of any of the Group B and D Example Embodiments; power supply circuitry configured to supply power to the processing circuitry.

Example Embodiment E3. A user equipment (UE) for assisted feature correlation estimation, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the Example Embodiment E4, wherein the cellular network further includes a network node configured to communicate with the UE to transmit the user data to the UE from the host.

Example Embodiment E6. The host of any one of Example Embodiments E4 or E5, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Emboidment E8. The method of Example Embodiment E7, further comprising: at the host, executing a host application associated with a client application executing on the UE to receive the user data from the UE.

Example Embodiment E9. The method of Example Embodiment E8, further comprising: at the host, transmitting input data to the client application executing on the UE, the input data being provided by executing the host application, wherein the user data is provided by the client application in response to the input data from the host application.

Example Emboidment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Emboidment E11. The host of Example Embodiment E10, wherein the cellular network further includes a network node configured to communicate with the UE to transmit the user data from the UE to the host.

Example Embodiment E12. The host of any one of Example Embodiments E10 or E11, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the Example Embodiment E13, further comprising: at the host, executing a host application associated with a client application executing on the UE to receive the user data from the UE.

Example Embodiment E15. The method of Example Embodiment E14, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of Example Embodiment E16, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of Example Embodiment E18, further comprising, at the network node, transmitting the user data provided by the host for the UE.

Example Emboidment E20. The method of any of Example Embodiments E18 to E19, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of Example Embodiment E21, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of any of Example Embodiments E22 to E23, wherein: the processing circuitry of the host is configured to execute a host application, thereby providing the user data; and the host application is configured to interact with a client application executing on the UE, the client application being associated with the host application.

Example Embodiment E25. The host of any of Example Embodiments E23 to E24, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of Example Embodiment E26, further comprising at the network node, transmitting the received user data to the host.

What is claimed:

1. A method performed by a user equipment, UE, for assisted feature correlation estimation, the method comprising:
transmitting, to a network node, assistance information for input into a machine learning model, the assistance information comprising at least one correlation between a plurality of features.

2. The method of claim 1, wherein the plurality of features comprise at least a first feature and a second feature, and wherein the at least one correlation comprises a relation measured between the first feature and the second feature.

3. The method of claim 1, wherein the assistance information comprises a plurality of values, each one of the plurality of values measuring a relation between at least two of the plurality of features.

4. (canceled)

5. The method of claim 1, comprising:
performing at least one measurement;
storing at least one value associated with each one of the at least one measurements that are performed; and
determining and/or calculating the at least one correlation between the plurality of features based on the at least one measurement.

6.-7. (canceled)

8. The method of claim 5, comprising:
receiving, from the network node, an indication of at least one subset of the plurality of features; and
performing at least one additional measurement for the at least one subset of the plurality of features.

9. The method of claim 1, comprising determining that at least one reporting condition is fulfilled, wherein the assistance information is transmitted to the network node based on the at least one reporting condition being fulfilled.

10. The method of claim 9, wherein determining that the at least one reporting condition is fulfilled is based on at least one of:
detecting a change in a Radio Resource Control, RRC, state at the UE;
detecting an expiration of a time period for periodically reporting the assistance information;
performing a number of measurements that is greater than a threshold;
determining that a memory buffer storing the assistance information is full;
determining that a number of measurements is outside an acceptable operational range;
receiving a request from the network node;
determining a change in location and/or determining a change in a cell of the UE;
computing a correlation value that is associated with the at least one reporting condition; and
detecting a change in a correlation value that greater than a threshold.

11. The method of claim 1, comprising transmitting, to the network node, information indicating a capability of the UE to perform feature correlation estimation and/or a capability of the UE to provide the assistance information.

12. The method of claim 1, comprising receiving, from the network node, information indicating a capability of the network node to receive the assistance information.

13. The method of claim 1, comprising receiving, from the network node, a configuration for performing correlation estimation between the plurality of features.

14. (canceled)

15. The method of claim 1, comprising:
receiving, from the network node, a machine learning model that is at least partially based on the assistance information; and
using the machine learning model to perform at least one operation.

16. The method of claim 15, wherein using the machine learning model to perform the at least one operation comprises at least one of:
inferring the value of the first feature based on the value of the second feature;
predicting a strength or quality of a beam;
selecting a reference signal for performing at least one measurement;
determining not to perform at least one measurement; and
predict a change in a signal quality.

17. The method of claim 1, comprising:
receiving, from the network node, correlation information associated with one or more other UEs; and
determining, based on the correlation information associated with the one or more other UEs, at least one input feature for a machine learning model received from the network node or generated by the UE.

18. A method performed by a network node for assisted feature correlation estimation the method comprising:
receiving, from at least one user equipment, UE, assistance information comprising at least one correlation between a plurality of features; and
performing at least one network operation based on the assistance information.

19.-27. (canceled)

28. The method of claim 18, comprising at least one of:
receiving, from the at least one UE, information indicating a capability of the at least one UE to perform feature correlation estimation and/or a capability of the at least one UE to provide the assistance information; and
transmitting, to the at least one UE, information indicating a capability of the network node to receive the assistance information.

29.-31. (canceled)

32. The method of claim 18, wherein performing the at least one network operation comprises:
determining, based on the assistance information, at least one of the plurality of features to use as input for a machine learning model; and
based on the input, using the machine learning model to perform at least one of:
infer the value of the first feature based on the value of the second feature;
predict a strength or quality of a beam;
select a reference signal for performing at least one measurement;
determine not to perform at least one measurement; and
predict a change in a signal quality.

33. The method of claim 32, comprising transmitting, to the at least one UE, the machine learning model.

34. The method of claim 18, wherein assistance information is received from a plurality of UEs, and the method comprises:
transmitting, to at least a first one of the plurality of UEs, the assistance information received from at least a second one of the plurality of UEs.

35. A user equipment, UE, for assisted feature correlation estimation, the UE configured to:
transmit, to a network node, assistance information for input into a machine learning model, the assistance information comprising at least one correlation between a plurality of features.

36. (canceled)

37. A network node for assisted feature correlation estimation, the network node configured to:
receiving, from at least one user equipment, UE, assistance information comprising at least one correlation between a plurality of features; and
performing at least one network operation based on the assistance information.

38. (canceled)
